(19) United States
(12) Patent Application Publication
(10) Pub. No.: US 2026/0200669 A1
(43) Pub. Date: Jul. 16, 2026

(54) MULTI-DIMENSIONAL CONFIGURABLE CONTAINER OPTIMIZATION SYSTEM

(71) Applicant: SLIP ROBOTICS INC., Norcross, GA (US)

(72) Inventors: John Martin JAKOMIN, Lawrenceville, GA (US); Christopher Rand SMITH, Dacula, GA (US); Dennis Jacob Lee SIEDLAK, Sandy Springs, GA (US)

(21) Appl. No.: 19/448,616

(22) Filed: Jan. 14, 2026

Related U.S. Application Data
(60) Provisional application No. 63/745,236, filed on Jan. 14, 2025.

(51) Int. Cl. B65G 1/02

(52) U.S. Cl. CPC B65G 1/02

(57) ABSTRACT

A configurable optimization system includes a platform, a plurality of side support plates secured to the platform, at least one cross member connecting the plurality of side support plates and at least one load bar that extends between the plurality of side support plates. Each side support plate of the plurality of side support plates includes a plurality of vertically and horizontally stacked slots for securing the at least one load bar.

### CROSS-REFERENCE TO RELATED APPLICATIONS

This application claims the benefit of, and priority to, U.S. Provisional Patent Application No. 63/745,236, filed on January 14, 2025, AND entitled “MULTI-DIMENSIONAL CONFIGURABLE CONTAINER OPTIMIZATION STORAGE,” the contents of which are hereby incorporated by reference in its entirety.

### TECHNICAL FIELD

This application relates generally to systems and methods for optimizing internal space of a container and/or trailer and, more particularly, but not by way of limitation, to an insertable modular system capable of organizing merchandise within the container and/or trailer.

### BACKGROUND OF THE INVENTION

The distribution of goods forms a vital part of any nation's economy. Optimizing shipping efficiency can be a key technique for minimizing transportation costs associated with the distribution of goods. For example, trailer and/or container volumetric efficiency can be difficult to optimize especially with mixed cargo such as, for example, odd-shaped cargo, non-stackable cargo, or the like. Though some attempts have been made to use standardized equipment (e.g., load bars) to organize trailers and/or containers, these systems are time-intensive, expensive, heavy, and require specialized trailers and/or containers. These systems also require loading and unloading of the trailer in a predefined order which can delay access to important or time sensitive cargo within the trailer. Additionally, these customized trailers and/or containers cannot always perform typical journeys. Other solutions include inefficient single-purpose packing solutions such as, for example, purpose-built racks, bins, carts, or the like. These solutions have extremely limited uses, can be economically wasteful, and are difficult to store. Along with being economically inefficient, prior solutions require time-intensive loading and unloading intervals. Furthermore, the prior solutions still struggle with stacking non-standard-width cargo and promote further difficulties when unloading and loading cargo in less-than-ideal conditions such as, for example, in dark conditions, in hot weather, in cold weather, on unstable trailers, or the like.

Therefore, there is a long-felt but unresolved need for a system or method that can reduce the time needed to unload and load trailers and/or containers, can easily and efficiently store unconventional cargo, can load and unload a particular trailer and/or container in less-than-ideal conditions, can integrate with existing equipment, and can function modularly, such that the system can be used for any particular cargo and stored in any particular type of trailer and/or container.

### SUMMARY

A configurable optimization system includes a platform, a plurality of side support plates secured to the platform, at least one cross member connecting the plurality of side support plates and at least one load bar that extends between the plurality of side support plates. Each side support plate of the plurality of side support plates includes a plurality of vertically and horizontally stacked slots for securing the at least one load bar.

A configurable optimization system includes a platform and a plurality of side support plates secured to the platform. The plurality of side support plates include a first side support plate having a plurality of vertically and horizontally stacked slots and a second side support plate having a plurality of vertically and horizontally stacked slots. The configurable optimization system includes at least one cross member connecting the plurality of side support plates. The first side support plate and the second side support plate are positioned parallel to each other and secured to the platform to form a first bay. The configurable optimization system further includes a first load bar that is secured between the first side support plate and the second side support plate at a first height to support a first load and a second load bar that is secured between the first side support plate and the second side support plate at a second height to support a second load. The first bay includes a first side and a second side allowing multiple power industrial vehicles (PIVs) to simultaneously access the configurable optimization system to at least one of load and unload at least one of the first load and the second load.

A configurable optimization system includes a platform and a plurality of side support plates secured to the platform. The plurality of side support plates include a first side support plate having a plurality of vertically and horizontally stacked slots, a second side support plate having a plurality of vertically and horizontally stacked slots and a third side support plate having a plurality of vertically and horizontally stacked slots. At least one cross member connects the plurality of side support plates. The first side support plate and the second side support plate are positioned parallel to each other and secured to the platform to form a first bay. The second side support plate and the third side support plate are positioned parallel to each other and secured to the platform to form a second bay. A first load bar is secured between the first side support plate and the second side support plate at a first height to support a first load. A second load bar is secured between the first side support plate and the second side support plate at a second height to support a second load. A third load bar is secured between the second side support plate and the third side support plate at a third height to support a third load. A fourth load bar is secured between the second side support plate and the third side support plate at a fourth height to support a fourth load. Each of the first and second bays include a first side and a second side allowing multiple power industrial vehicles (PIVs) to simultaneously access the configurable optimization system to at least one of load and unload at least one of the first, second, third and fourth loads.

### BRIEF DESCRIPTION OF THE DRAWINGS

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed systems and processes, and wherein:

FIG. 1A illustrates a perspective view of a configurable optimization system, according to one example of the disclosed technology;

FIG. 1B illustrates a perspective view of a configurable optimization system attached to an automated platform, according to one example of the disclosed technology;

FIG. 1C illustrates a perspective view of a configurable optimization system of FIG. 1B being loaded and/or unloaded with cargo by multiple loaders, according to one example of the disclosed technology;

FIG. 2 illustrates a top view of a configurable optimization system, according to one example of the disclosed technology;

FIG. 3 illustrates a first side view of a configurable optimization system, according to one example of the disclosed technology;

FIG. 4 illustrates a second side view of a configurable optimization system, according to one example of the disclosed technology;

FIG. 5 illustrates a bottom view of a configurable optimization system, according to one example of the disclosed technology;

FIG. 6 illustrates a perspective view of a configurable side support plate, according to one example of the disclosed technology;

FIG. 7 illustrates a perspective view of a cross member, according to one example of the disclosed technology; and

FIG. 8 is a flow diagram of an illustrative process for increasing unloading and loading efficiency of the configurable optimization system, according to one example of the disclosed technology.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, as used herein, the term “coupled” may include direct or indirect coupling by any means, including moving and/or non-moving mechanical connections.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Exemplary embodiments disclose systems and methods for volumetric organization of trailers and/or containers. A container and/or trailer can include any shipping container used to transport goods. For example, the trailers can include any trailer attached to a truck or wheeled vehicle. In another example, containers can include any rectangular shipping container stored on at least one of cargo ships and any other vehicle. The foregoing discussion will focus on trucks and their associated trailers, though the disclosed system can be used for any particular shipping container.

According to exemplary embodiments, the disclosed technology can include a configurable optimization system. The configurable optimization system can include one or more configurable side support plates, cross members, and load bars to build a unique rack configuration capable of supporting various cargo. The configurable optimization system can be built, loaded, and unloaded outside of the trailer. For example, the configurable optimization system can be arranged to support any particular set of cargo and subsequently loaded with the set of cargo. The configurable optimization system has multiple access points so in some embodiments, the configurable optimization system may be loaded by multiple loaders at the same time, such as, for example, two loaders, three loaders, four loaders, or the like. Continuing this example, once configured and loaded (e.g., driven), the configurable optimization system can be loaded onto a particular trailer. By configuring and loading the configurable optimization system outside of the trailer, the loading and unloading efficiency of the trailer can be increased while maximizing the volumetric efficiency of the trailer.

The configurable optimization system can be at least one of integrated, fixed, or supported by an automated platform. The automated platform can function as a robotic system capable of driving cargo into a particular container and/or trailer. For example, the configurable optimization system can be attached through any particular attachment method (e.g., bolted, welded, or the like) to the automated platform. The automated platform can facilitate the loading and unloading process. For example, once the configurable optimization system has been configured and loaded outside of the confines of the trailer, the automated platform can automatically drive within the trailer for subsequent storage and/or transportation. Continuing this example, once the trailer has reached its final destination, the automated platform can disembark the trailer such that the cargo can be accessed outside of the confines of the trailer. The disclosed system can allow for greater access during the loading process by allowing multiple power industrial vehicles (PIVs) such as, for example, forklifts to unload and load the configurable optimization system while outside of the container and/or trailer. This advantage can allow for greater modularity (e.g., differing configurations of cargo stacked in different locations), increased volume efficiency, greater access to the cargo, reduced times for loading and unloading, allow for selective unloading and loading at quicker rates, and reduce the overall cost associated with loading and unloading the container and/or trailer.

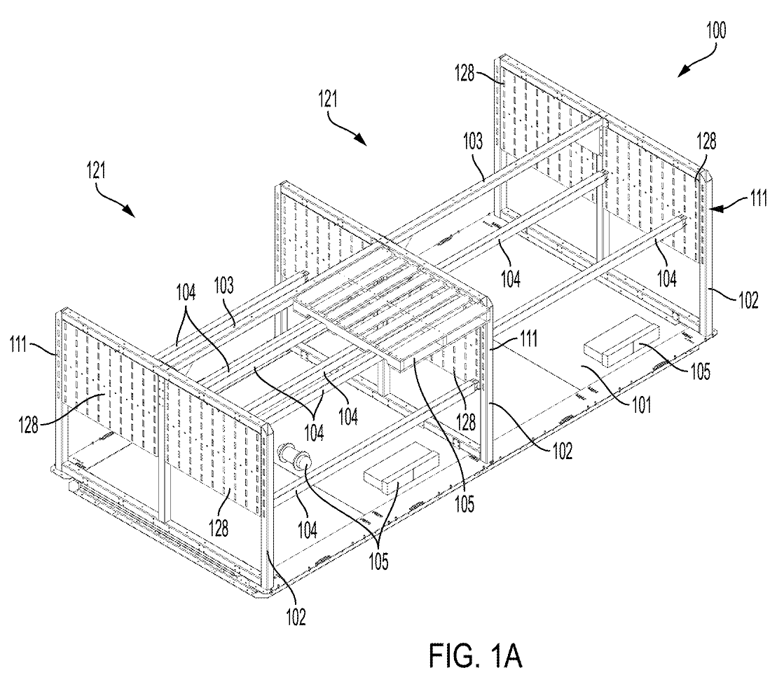

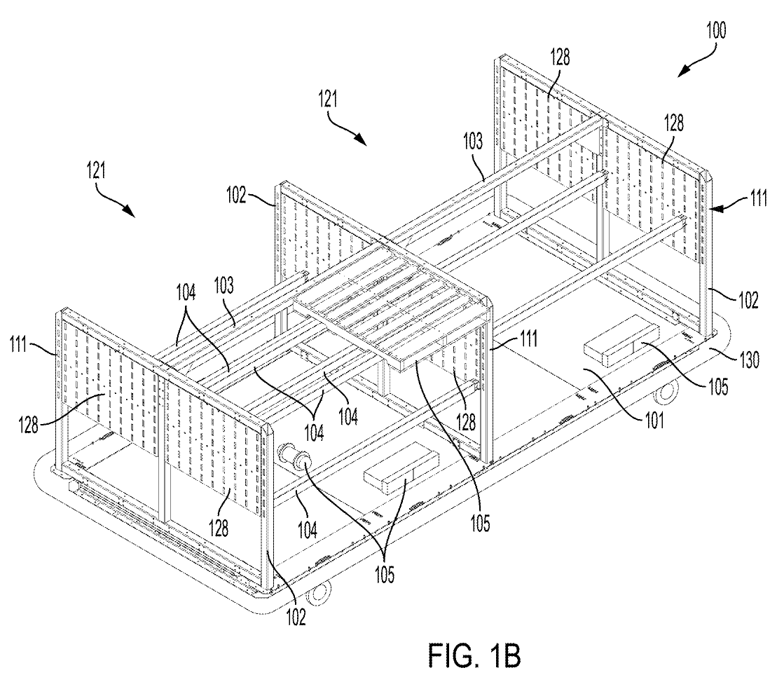

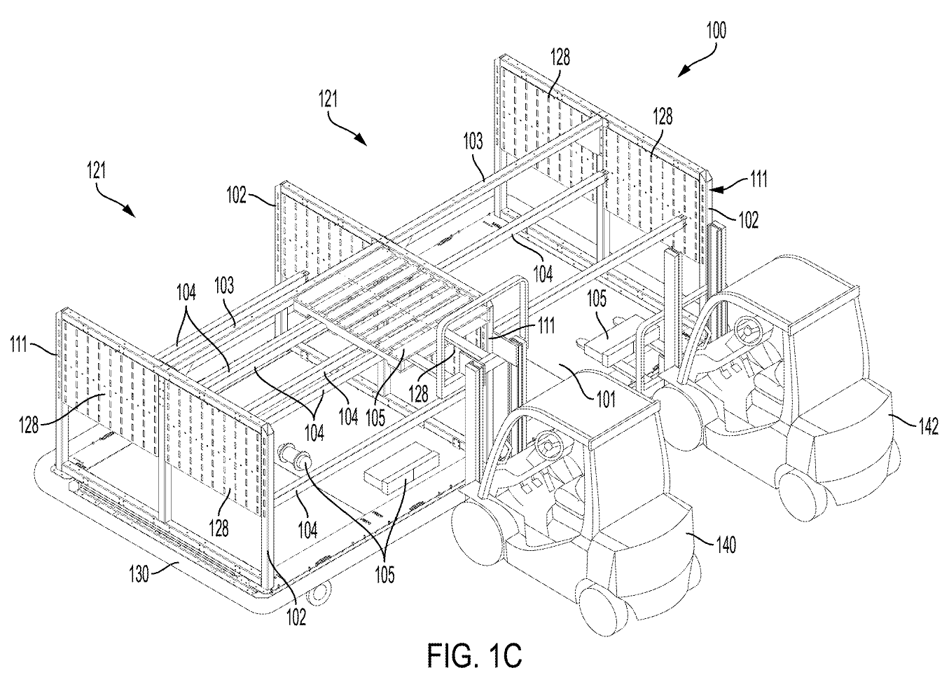

FIG. 1A illustrates a perspective view of an exemplary configurable optimization system 100. As will be understood and appreciated, the configurable optimization system 100 shown in FIG. 1A represents merely one approach or example of the present system, and other aspects are used according to various examples of the present system. FIG. 1B illustrates a perspective view of the configurable optimization system 100 of FIG. 1A attached to an automated platform 130, according to one example of the disclosed technology. FIG. 1C illustrates a perspective view of the configurable optimization system 100 of FIG. 1B being loaded and/or unloaded with cargo by multiple loaders 140, 142. As will be understood and appreciated, the configurable optimization system 100 shown in FIG. 1C illustrates loading and/or unloading cargo from the configurable optimization system 100 of FIG. 1B; however, the same concept of loading and/or unloading cargo can be applied to the configurable optimization system 100 of FIG. 1A.

Referring now to FIGS. 1A-1C, the configurable optimization system 100 can function as a preconfigurable cargo containment system used to load and unload trailers and/or containers. Trailers and/or containers can include any particular container used to transport goods on any particular vehicle. For example, trailers and/or containers can include but are not limited to shipping containers stored on cargo ships, trailers of any particular size attached and/or pulled by a land vehicle, train railcars, aircraft storage units, aircraft storage bays, and/or any particular container used to carry and/or transport goods. Though the configurable optimization system 100 can be used in any particular container and/or trailer, the foregoing discussion focuses on the use of the configurable optimization system 100 for organizing trailers pulled by trucks.

In a typical embodiment, the configurable optimization system 100 includes a platform 101, one or more configurable side support plates 102 (also referred to herein as a configurable side support structure), at least one cross member 103, and one or more load bars 104. The platform 101 can function as a base of the configurable optimization system 100. For example, the platform 101 can receive one or more cargo 105, support the configurable side support plates 102, and/or support the weight of a loaded configurable optimization system 100.

The configurable side support plates 102 can secure to the platform 101. In a typical embodiment, the configurable side support plates 102 can attach to the platform 101 via, for example, bolts, fasteners, or any particular attachment mechanism. The configurable side support plates 102 can function as walls that are configured to receive and support various cargo support apparatuses such as, for example, the load bars 104 that are configured to support the cargo 105. For example, one or more load bars 104 can be attached to and between two adjacent configurable side support plates 102. Continuing this example, once the load bars 104 are attached to and between the two adjacent configurable side support plates 102, the cargo 105 can be stacked on the load bars 104. The load bars 104 and the configurable side support plates 102 can support the weight of the cargo 105. For illustrative purposes, the configurable optimization system 100 is described as having three side support plates 102 and eight load bars 104; however, in other embodiments, any number of side support plates 102 and load bars 104 may be included in the configurable optimization system 100 as dictated by design requirements.

In a typical embodiment, the configurable side support plates 102 can include, for example, one or more e-tracks 111 on each side of the configurable side support plates 102. The e-tracks 111 can include any particular cargo rail system. For example, the e-tracks 111 can be substituted for L-tracks, f-tracks, unistruts, or any other cargo rail system used to support the cargo 105. The one or more e-tracks 111 can include a series of adjacent vertically stacked slots 128. Each particular slot 128 can receive an attachment mechanism used to secure the particular cargo support apparatus. For example, one or more slots 128 of the e-track 111 can receive an attachment hook for the one or more load bars 104. Continuing this example, the load bars 104 can extend between two configurable side support plates 102 such that the load bars 104 are fastened between the two configurable side support plates 102. The e-tracks 111 are designed to include one or more industry-standardized slots such that any industry-standardized cargo support apparatus can be attached to the configurable side support plates 102. For example, the e-tracks 111 can receive and attach to straps for securing cargo 105, holders for the load bars 104, tool bins, rings for other types of tie downs, cargo nets, sockets for wooden supports, hooks, or any other particular cargo support apparatus capable of holding and supporting the cargo 105. By including the industry standardized e-tracks 111, the configurable optimization system 100 can use readily available cargo support apparatuses (e.g., the load bars 104) to support a wide range of cargo 105. Furthermore, by using various e-tracks 111, the cargo support apparatus can be attached in a wide variety of configurations to support varying sizes of cargo 105 and/or varying stacking configurations of the cargo 105.

The configurable optimization system 100 can be configured to hold cargo 105 of varying sizes. For example, the configurable optimization system 100 can include one or more load bars 104 used to support the weight of the cargo 105. In some embodiments, the load bars 104 do not require tools to engage and disengage with one or more slots 128. The load bars 104 can be advantageous because the load bars 104 do not utilize heavy connection pieces or clips to support weight. Weight can be supported by the load bars 104 and the load can be transferred to the configurable side support plates 102. The load can transfer from the configurable side support plates 102 to the platform 101. The configurable side support plates 102 can couple to the platform 101 to provide mechanical support including to prevent movement from forces perpendicular to each of the configurable side support plates 102 as well as to support the weight of the cargo 105.

In a typical embodiment, the cargo 105 can include any particular cargo regardless of, for example, shape, size, weight, or containment requirement. For example, the cargo 105 can include, but is not limited to, one or more shipping pallets with uniform dimensions, one or more shipping pallets with distinct dimensions, netting carrying various loose items, rigid materials (e.g. solid pipes), non-ridged materials (e.g., hoses), liquid storage units, pipe carriers, or any particular cargo that can be transported in a trailer and/or container.

In a typical embodiment, the configurable optimization system 100 can include one or more bays 121. Each bay 121 can include, for example, two configurable side support plates 102 connected through the cross member 103. The cross member 103 can function as a support system capable of supporting at least one of the suspended load of the cargo 105 and the configurable optimization system 100 while the tractor-trailer brakes or accelerates with the truck. By including separate bays 121, each bay 121 can be configured to carry unique cargo 105 distinct from the cargo 105 held in the adjacent bay 121. For illustrative purposes, the configuration optimization system 100 is illustrated as having two bays 121; however, in other embodiments, the configuration optimization system 100 can include any number of bays 121 as dictated by design requirements. For example, the configurable optimization system 100 can include a single bay 121 configuration for shorter trailer widths. In another example, the configurable optimization system 100 can include two, three or four bays 121 for larger trailers.

The configurable optimization system 100 can include the platform 101. The platform 101 can be a standalone platform configured to attach to an automated platform 130. The uppermost surface of the automated platform 130 can function as the platform 101. In another example, the configurable optimization system 100 can include the platform 101 that is not attached to the automated platform 130 and is loaded onto the trailer using, for example, a forklift, wheels, or other loading systems. The various components and uses of the automated platform are described in further detail in U.S. Patent App. No. 17/224,854, filed April 7, 2021, entitled PLATFORM APPARATUSES, U.S. Patent App. No. 18/455,100, filed August 24, 2023, entitled PLATFORM APPARATUSES, and U.S. Patent App. No. 19/002,320, filed December 26, 2024, entitled PLATFORM APPARATUSES, the entire contents of which are incorporated by reference as if fully set forth herein.

The platform 101 can include a standalone platform capable of receiving the configurable optimization system 100. For example, the configurable optimization system 100 can attach to the uppermost surface of the automated platform 130 via, for example, bolts, fasteners, clips, or any particular attachment system capable of supporting a loaded configurable optimization system 100. In another example, the platform 101 can include the uppermost surface of the automated platform 130. Continuing this example, one or more configurable side support plates 102 can be integrated into the uppermost surface of the automated platform 130 functioning as the platform 101.

In a typical embodiment, the automated platform 130 can function as a driving robotic system (either controlled and/or autonomously moving) capable of driving cargo 105 on and/or off of the trailer. By including the configurable optimization system 100, the automated platform 130 can drive the configurable optimization system 100 on and/or off of the trailer. Traditional loading of trailers required PIVs to load the trailer from a singular entrance, which reduced the possible stacking configurations, increased the time needed to load and unload the trailer, and increased inefficiencies associated with loading and unloading the trailer. By integrating the configurable optimization system 100 into the automated platform 130, the configurable optimization system 100 can be loaded with distinct cargo 105 at differing angles and by multiple PIVs 140, 142 simultaneously (e.g., 2, 3, or 4 forklifts) since the configurable optimization system 100 is not within the confines of the trailer and is accessible from multiple sides. For illustrative purposes, the configurable optimization system 100 is illustrated as being loaded by two PIVs 140, 142; however, in other embodiments, any number PIVs may be utilized to load the configurable optimization system 100 as dictated by design requirements Once the configurable optimization system 100 is loaded, the automated platform 130 can drive the cargo 105 into the trailer, significantly reducing the time needed to load the trailer while also filling the entire volumetric space of the trailer with the pre-loaded configurable optimization system 100. Additionally, by being able to load and unload the configurable optimization system 100 outside of the trailer, specific cargo 105 can be loaded and unloaded at any particular time. This can be beneficial over traditional techniques, as traditional techniques require loading and/or unloading from one entrance and any cargo initially loaded at the end of the trailer will be the last to be unloaded from the trailer, and vice versa. Using the configurable optimization system 100 and the automated platform 130, once removed from the trailer, the cargo 105 carried by the configurable optimization system 100 can be accessed outside of the trailer regardless of its relative position when stored in the trailer.

By attaching the configurable optimization system 100 to the automated platform 130, the automated platform 130 can drive the configurable optimization system 100 to any particular position. For example, the automated platform 130 can include a particular unloaded configurable optimization system 100 outside of the confines of a particular trailer. By being outside of the confines of the trailer, the configurable optimization system 100 can be loaded and/or unloaded with cargo 105 at various different angles and by various different PIVs 140, 142 simultaneously, thus reducing the difficulty of loading a traditional trailer and increasing the loading and unloading time. Once the configurable optimization system 100 has been loaded, the automated platform 130 can drive itself into the trailer with the loaded configurable optimization system 100. In a typical embodiment, the automated platform 130 can travel with and support the configurable optimization system 100. After transportation, the automated platform 130 can drive off of the trailer such that the cargo 105 can be accessed and unloaded from the configurable optimization system 100. The automated platform 130 can embark and disembark the trailer in any particular environment (e.g., in dark conditions, in cold temperatures, in hot temperatures, uneven trailers, etc.), therefore further reducing the difficulty of unloading the trailer as compared to traditional methods.

In some embodiments, more than one automated platform 130 with the configurable optimization system 100 can drive onto the trailer and/or container. For example, in a particular trailer that is configured for two automated platforms 130 with the configurable optimization systems 100, the two automated platforms 130 can drive onto the particular trailer for storage and/or transportation. In another example, in a 53-foot-long trailer, six automated platforms including the configurable optimization systems 100 can drive into the 53-foot-long trailer. Any particular number of automated platforms 130 each including the configurable optimization system 100 can drive into a particular container and/or trailer using standardized lengths for the bays 121, the load bars 104, and/or any particular cargo support apparatus. In some embodiments, one or more automated platforms 130 including the configurable optimization system 100 can drive into a trailer along with one or more automated platforms 130 excluding the configurable optimization system 100.

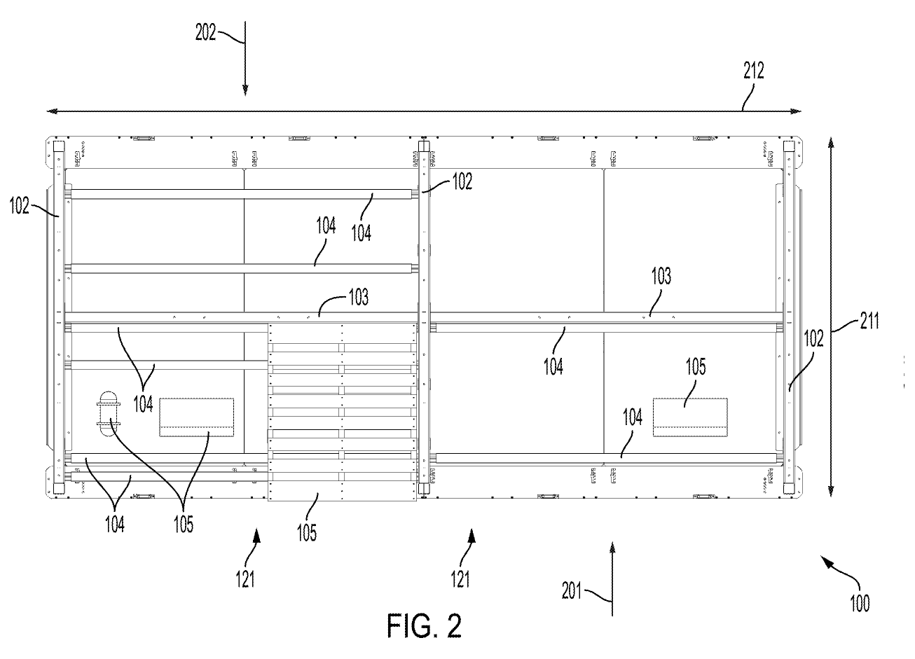

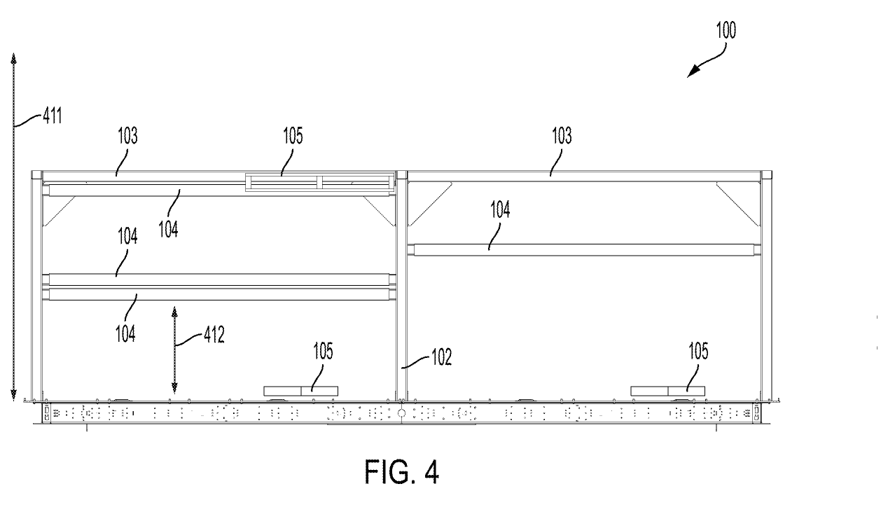

FIG. 2 illustrates a top view of a configurable optimization system 100, according to one example of the disclosed technology. For illustrative purposes, FIG. 2 will be described herein relative to 1A-1C. In a typical embodiment, the configurable optimization system 100 can include bays 121 that are sized to fit in traditional trailers. For example, the two bays 121 of the configurable optimization system 100 can be configured to hold 8 layers of 48-inch x 45-inch cargo 105. The configurable optimization system 100 can include a length 211, a width 212, and a height 411 (see FIG. 4 for further details), such that the configurable optimization system 100 can fit into an industry-standard trailer. For example, the width 212 can measure at least 180 inches, allowing for the storage of two 45-inch x 48-inch pallets in each bay 121 (e.g., 4 total pallets along the width 212 of the entire configurable optimization system 100) within the footprint of the configurable optimization system 100.

In a typical embodiment, the configurable optimization system 100 can be accessible by PIVs 140, 142 such as, for example, forklifts, lift trucks, platform trucks or the like from at least one of a first side 201 and a second side 202. By loading and unloading the configurable optimization system 100 outside of the trailer, the configurable optimization system 100 can be accessible from the first side 201 and the second side 202. By accessing the configurable optimization system 100 from the first side 201 and the second side 202, load times can be decreased by increasing access points and allowing multiple PIVs 140, 142 to simultaneously access the configurable optimization system 100. The configurable optimization system 100 can allow for unique configurations of stacking and storing cargo 105. The configurable optimization system 100 can increase the utilization of the trailer by allowing loaders to configure the configurable optimization system 100 to hold varying types of cargo 105 of differing dimensions and reduce volumetric waste.

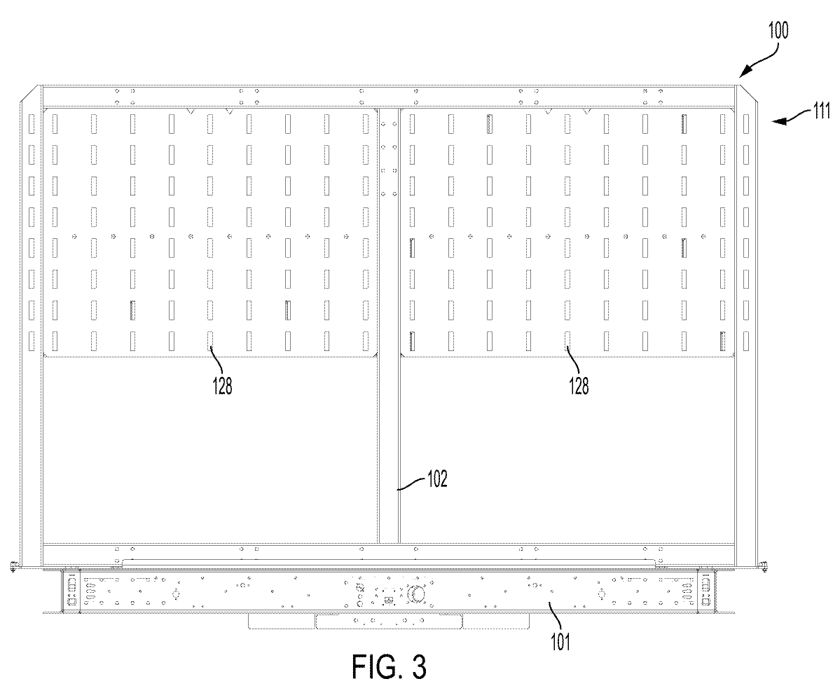

FIG. 3 illustrates a first side view of a configurable optimization system 100, according to one example of the disclosed technology. For illustrative purposes, FIG. 3 will be described herein relative to 1A-2. In a typical embodiment, the configurable optimization system 100 can include, for example, one or more e-tracks 111 on each side of the configurable side support plates 102. In a typical embodiment, the one or more e-tracks 111 can include various equally spaced slots 128 arranged, for example, horizontally and vertically. For illustrative purposes, the configurable optimization system 100 is illustrated as having 8 e-tracks 111 stacked vertically; however, in other embodiments, the configurable optimization system 100 can include any configuration of vertically stacked e-tracks 111 as dictated by design requirements. By varying the number of e-tracks 111, various height, width, and length configurations can be created to support various forms of cargo 105. The slots 128 are configured to receive one or more hooks or other attachment devices to attach to one or more of the cargo support apparatuses such as, for example, the load bars 104 at different heights.

The configurable optimization system 100 can provide for multi-dimensional load configurations. For example, a set of load bars 104 can be placed at different heights to support pallets or other loads at that height. Another set of load bars 104 can be placed at a different height to support another load. One or more load bars 104 can be placed occupying only a portion of a bay 121. As an example, a first load can occupy a first horizontal portion of the bay 121 at a first height and a second load can occupy a remaining horizontal portion of the bay 121 at the first height or potentially a different height by selectively placing load bars 104. Continuing this example, third and fourth loads can be placed at different heights occupying other horizontal portions at different heights (e.g., above or below the first horizontal position). In a typical embodiment, the first, second, third and fourth loads may be, for example, varying types of cargo 105.

The configurable side support structures 102 can attach to the platform 101. For example, the configurable side support structure 102 can attach to the platform 101 through any particular fastening method discussed herein. The platform 101 can include a standard platform 101 loadable by the PIVs 140, 142 into a particular trailer or can include the uppermost surface of the automated platform 130.

Referring now to FIG. 4, illustrated is a second side view of the configurable optimization system 100, according to one example of the disclosed technology. For illustrative purposes, FIG. 4 will be described herein relative to 1A-3. The configurable optimization system 100 can include a height 411 and a second height 412. The height 411 can measure the maximum height the configurable optimization system 100 can support cargo 105 for the particular trailer. For example, for trailers used to carry 48-inch by 45-inch by 48-inch (length by width by height) cargo 105, the height 411 can measure 96 inches (e.g., the height of two vertically stacked pallets). Continuing this example, the second height 412 can measure the height of one cargo 105 (e.g., 48 inches). The configurable optimization system 100 can be configured to hold cargo 105 of varying heights. For example, the load bars 104 can be set to the lowest e-track 111 on the configurable side support structure 102. When set to the lowest e-track 111, the second height 412 can measure at least 24 inches such that the configurable optimization system 100 can carry four vertically stacked 24-inch height cargo 105.

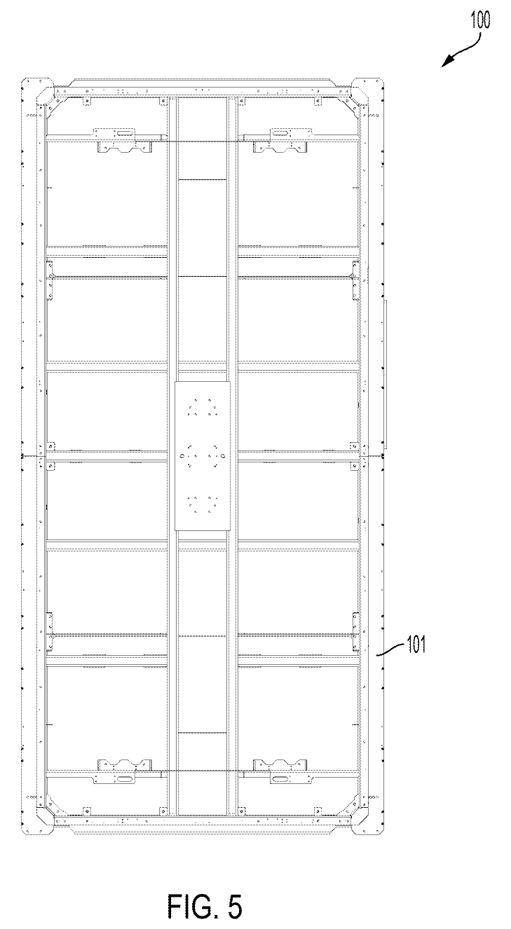

Referring now to FIG. 5, illustrated is a bottom view of the configurable optimization system 100, according to one example of the disclosed technology. For illustrative purposes, FIG. 5 will be described herein relative to 1A-4. The platform 101 can support the weight of the configurable optimization system 100. For example, the platform 101 can support at least 12,000 pounds, 12,000 pounds, or less than 12,000 pounds. The load bars 104 can support at least 3,000 pounds each, allowing a pair of the load bars 104 to support 6,000 pounds. By using load bars 104 that can support 6,000 pounds, half of the cargo 105 can be suspended above the platform on the load bars 104 while the remaining cargo weight is distributed across the platform 101. By using load bars 104 load bars with a maximum of 3,000 pounds of supported weight, the load bars 104, which are easily replaceable, can fail before the configurable optimization system 100 fails.

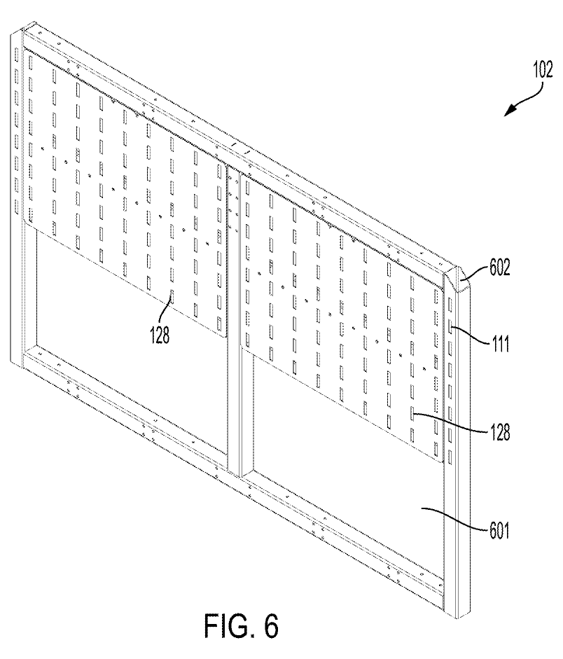

Referring now to FIG. 6, illustrated is the configurable side support plate 102, according to one example of the disclosed technology. For illustrative purposes, FIG. 6 will be described herein relative to 1A-5. The configurable side support plate 102 can include apertures 601. The apertures 601 can reduce the total weight of the configurable side support plate 102. In another example, the configurable side support plate 102 can include more e-tracks 111 in place of the apertures 601, where the additional e-tracks 111 can support new configurations for cargo support apparatuses. The configurable side support plate 102 can include a 45-degree chamfer-flat to match the angle of the automated platform and to facilitate easier loading and unloading.

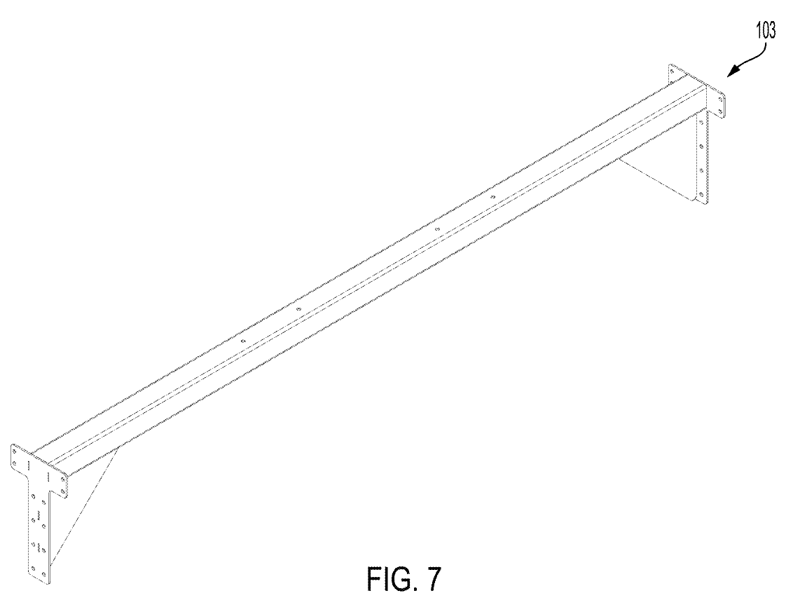

Referring now to FIG. 7, illustrated is the cross member 103, according to one example of the disclosed technology. For illustrative purposes, FIG. 7 will be described herein relative to 1A-6. The cross member 103 can support the weight of the configurable side support plate 102, the load bars 104, and/or the cargo 105 as the configurable optimization system 100 travels within the trailer. The cross member 103 functions as a support system capable of supporting at least one of the suspended load of the cargo 105 and the configurable optimization system 100 while the tractor-trailer brakes or accelerates with the truck.

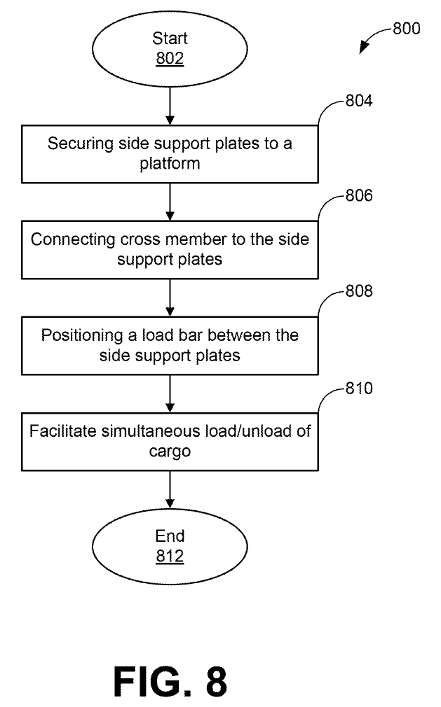

FIG. 8 is a flow diagram of an illustrative process 800 for increasing unloading and loading efficiency of the exemplary configurable optimization system 100. For illustrative purposes, FIG. 8 will be described herein relative to 1A-7. The process 800 begins at step 802. At step 804, a plurality of configurable side support plates 102 are secured to a platform 101. In a typical embodiment, the plurality of configurable side support plates 102 are positioned parallel to each other and secured to the platform 101 to form at least one bay 121. At step 806, at least one cross member 103 is connected the plurality of configurable side support plates 102. In a typical embodiment, the configurable side support plates 102 can include, for example, one or more e-tracks 111 on each side of the configurable side support plates 102. The e-tracks 111 can include any particular cargo rail system. For example, the e-tracks 111 can be substituted for L-tracks, f-tracks, unistruts, or any other cargo rail system used to support the cargo 105. The one or more e-tracks 111 can include vertically stacked slots 128. Each particular slot 128 can receive an attachment mechanism used to secure a particular cargo support apparatus (e.g., the at least load bar 104). At step 808, the at least one load bar 104 is positioned between the plurality of adjacent configurable side support plates 102. In a typical embodiment, the at least one load bar comprises a plurality of load bars 104 positioned between the plurality of adjacent configurable side support plates 102 at varying heights. At step 810, multiple power industrial vehicles PIVs 140, 142 simultaneously access the configurable optimization system 100 to at least one of load and unload varying types of 105. The process 800 ends at step 812.

According to exemplary embodiments, the disclosed technology can include the configurable optimization system 100. The configurable optimization system 100 can include the one or more configurable side support plates 102, the at least one cross member 103, and the one or more load bars 104 to build a unique rack configuration capable of supporting various types of cargo 105. The configurable optimization system 100 can be built, loaded, and unloaded outside of the trailer. For example, the configurable optimization system 100 can be arranged to support any particular set of cargo 105 and subsequently loaded with the set of cargo 105. The configurable optimization system 100 has multiple access points (e.g., the first side 201 and the second side 202 of the at least one bay 121) so in some embodiments, the configurable optimization system 100 may be loaded by multiple PIVs 140, 142 at the same time, such as, for example, two loaders, three loaders, four loaders, or the like. Continuing this example, once configured and loaded (e.g., driven), the configurable optimization system 100 can be loaded onto a particular trailer. By configuring and loading the configurable optimization system outside of the trailer, the loading and unloading efficiency of the trailer can be increased while maximizing the volumetric efficiency of the trailer. The disclosed configurable optimization system 100 can allow for greater access during the loading process by allowing multiple PIVs 140, 142 such as, for example, forklifts to unload and load the configurable optimization system while outside of the container and/or trailer. This advantage can allow for greater modularity (e.g., differing configurations of cargo 105 stacked in different locations), increased volume efficiency, greater access to the cargo 105, reduced times for loading and unloading, allow for selective unloading and loading at quicker rates, and reduce the overall cost associated with loading and unloading the container and/or trailer.

Conditional language used herein, such as, among others, "can," "might," "may," “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A configurable optimization system comprising:
a platform;
a plurality of side support plates secured to the platform;
at least one cross member connecting the plurality of side support plates;
at least one load bar that extends between the plurality of side support plates; and
wherein each side support plate of the plurality of side support plates comprises a
plurality of vertically and horizontally stacked slots for securing the at least one load bar.

2. The configurable optimization system of claim 1, wherein:
the plurality of side support plates comprise:
a first side support plate;
a second side support plate; and
wherein the first side support plate and the second side support plate are positioned parallel to each other and secured to the platform to form a first bay.

3. The configurable optimization system of claim 2, wherein:
the at least one load bar comprises:
a first load bar;
a second load bar;
the first load bar is secured between the first side support plate and the second side support plate at a first height to support a first load;
the second load bar is secured between the first side support plate and the second side support plate at a second height to support a second load; and
wherein the first load differs in dimensions than the second load.

4. The configurable optimization system of claim 3, wherein the first load occupies a first horizontal portion of the first bay at the first height.

5. The configurable optimization system of claim 4, wherein the second load occupies a second horizontal portion of the first bay at the second height.

6. The configurable optimization system of claim 5, wherein the first height is different than the second height.

7. The configurable optimization system of claim 6, wherein the first horizontal portion of the first bay is above the second horizontal portion of the first bay.

8. The configurable optimization system of claim 7, wherein the first horizontal portion of the first bay is below the second horizontal portion of the first bay.

9. The configurable optimization system of claim 8, wherein the first bay comprises a first side and a second side allowing multiple power industrial vehicles (PIVs) to simultaneously access the configurable optimization system to at least one of load and unload at least one of the first load and the second load.

10. The configurable optimization system of claim 1, wherein:
the plurality of side support plates comprise:
a first side support plate;
a second side support plate;
a third side support plate;
wherein the first side support plate and the second side support plate are positioned parallel to each other and secured to the platform to form a first bay; and
wherein the second side support plate and the third side support plate are positioned parallel to each other and secured to the platform to form a second bay.

11. The configurable optimization system of claim 10, wherein:
the at least one load bar comprises:
a first load bar;
a second load bar;
a third load bar; and
a fourth load bar.

12. The configurable optimization system of claim 11, wherein:
the first load bar is secured between the first side support plate and the second side support plate at a first height to support a first load;
the second load bar is secured between the first side support plate and the second side support plate at a second height to support a second load; and
wherein the first load differs in dimensions than the second load.

13. The configurable optimization system of claim 12, wherein:
the first load occupies a first horizontal portion of the first bay at the first height;
the second load occupies a second horizontal portion of the first bay at the second height; and
wherein the first height is different than the second height.

14. The configurable optimization system of claim 11, wherein:
the third load bar is secured between the second side support plate and the third side support plate at a third height to support a third load;
the fourth load bar is secured between the second side support plate and the third side support plate at a fourth height to support a fourth load; and
wherein the third load differs in dimensions than the fourth load.

15. The configurable optimization system of claim 14, wherein:
the third load occupies a third horizontal portion of the second bay at the third height;
the fourth load occupies a fourth horizontal portion of the second bay at the fourth height; and
wherein the third height is different than the fourth height.

16. The configurable optimization system of claim 1, wherein platform functions as a base of the configurable optimization system.

17. The configurable optimization system of claim 1, wherein platform is configured to attach to an automated platform that functions as a driving robotic system.

18. The configurable optimization system of claim 1, wherein the plurality of vertically and horizontally stacked slots comprise e-tracks.

19. A configurable optimization system comprising:
a platform;
a plurality of side support plates secured to the platform, wherein the plurality of side support plates comprise a first side support plate comprising a first plurality of vertically and horizontally stacked slots and a second side support plate comprising a second plurality of vertically and horizontally stacked slots;
at least one cross member connecting the plurality of side support plates;
wherein the first side support plate and the second side support plate are positioned parallel to each other and secured to the platform to form a first bay;
a first load bar secured between the first side support plate and the second side support plate at a first height to support a first load;
a second load bar secured between the first side support plate and the second side support plate at a second height to support a second load; and
wherein the first bay comprises a first side and a second side allowing multiple power industrial vehicles (PIVs) to simultaneously access the configurable optimization system to at least one of load and unload at least one of the first load and the second load.

20. A configurable optimization system comprising:
a platform;
a plurality of side support plates secured to the platform, wherein the plurality of side support plates comprise a first side support plate comprising a first plurality of vertically and horizontally stacked slots, a second side support plate comprising a second plurality of vertically and horizontally stacked slots and a third side support plate comprising a third plurality of vertically and horizontally stacked slots;
at least one cross member connecting the plurality of side support plates;
wherein the first side support plate and the second side support plate are positioned
parallel to each other and secured to the platform to form a first bay;
wherein the second side support plate and the third side support plate are positioned parallel to each other and secured to the platform to form a second bay;
a first load bar secured between the first side support plate and the second side support plate at a first height to support a first load;
a second load bar secured between the first side support plate and the second side support plate at a second height to support a second load;
a third load bar secured between the second side support plate and the third side support plate at a third height to support a third load;
a fourth load bar secured between the second side support plate and the third side support plate at a fourth height to support a fourth load; and
wherein each of the first and second bays comprise a first side and a second side allowing multiple power industrial vehicles (PIVs) to simultaneously access the configurable optimization system to at least one of load and unload at least one of the first, second, third and fourth loads.
